(19) United States
(12) Patent Application Publication
(10) Pub. No.: US 2008/0296800 A1
(43) Pub. Date: Dec. 4, 2008

(54) Flyash Aggregate

(75) Inventor: Warren Howard Smith, Coomba Park New South Wales (AU)

Correspondence Address: MICHAEL MOLINS;MOLINS & CO., SUITE 5, LEVEL 6, 139 MACQUARIE ST, SYDNEY NSW, 2000, AU

(73) Assignee: Flyash Designer Aggregates Pty Ltd, Comba Park NSW (AU)

(21) Appl. No.: 12/093,951

(22) PCT Filed: Nov. 16, 2006
(86) PCT No.: PCT/AU2006/001714

§ 371 Date: May 16, 2008

(30) Foreign Application Priority Data
Dec. 2, 2005 (AU) 2005906785

(51) Int. Cl. B28B 5/00; C04B 18/06; B28B 17/02

(52) U.S. Cl. 264/228; 106/705; 425/200

(57) ABSTRACT

Described in this specification is a formula for a light weight flyash aggregate for concretes, as well as the method for producing the aggregate and the facilities needed to produce the aggregate. The compaction and bonding of the flyash is facilitated by essentially pure fine washed sands, with the presence of a binding agent that is a caustic soda solution.

### FIELD OF THE INVENTION

The invention pertains to aggregates for concrete and more particularly to aggregates produced from flyash.

### BACKGROUND OF THE INVENTION

Flyash is a fine ash produced as a by-product of the burning of coal during the production of electricity.

In the USA alone, about 60 million tonnes of flyash are produced annually. India produces over 100 million tonnes per year. Waste flyash is used in the building industry, for example, as an additive to cement. However, with about 70% of flyash going into landfill, private industry, the power industry and governments continue to seek new ways of utilising the vast amount of this material that are being produced as the world wide demand for power increases. With a typical coal burning power station producing about 150-200 tonnes of flyash per hour (equal to about 1.75 millions tonnes per year) the present invention provides a response to deeply felt need.

The present invention proposes the utilisation of waste flyash as an ingredient in a light weight aggregate that can be used in concrete. Light weight aggregates can be used in a light weight concrete composition. Light weight concretes are considered advantageous and desirable in the construction industry. Further, the invention results in a generally smooth spherical pellet that is less abrasive than conventional aggregate and therefore less damaging to concrete pumps. There is about 1 tonne of coarse aggregate in a cubic meter of concrete. Australia alone consumes 5 billion dollars worth of dense concrete using 30 million tonnes per year of coarse quarry aggregate (10-20 mm). As Australia's consumption of concrete is growing by about 6% annually it is reasonable to conclude that there is a significant market for light weight concrete world wide.

At the present time, the only light weight aggregate generally available in Australia is an aggregate referred to as Scoria which comes from Victoria. Because of the cost of transportation, this product is sometimes twice the cost of normal aggregates that are delivered to concrete plants.

Thus, there are vast amounts of flyash readily available for use. Further, the technology currently used in coal fired power houses is not likely to change over the next 20 years. Therefore the supply of fly ash is expected to remain steady for many years to come.

### OBJECTS AND SUMMARY OF THE INVENTION

It is an object of the invention to provide a composition for the production of a light weight aggregate.

It is another object of the invention to provide methods and apparatus for the production of a light weight aggregate.

It is another object of the invention to provide ways of beneficially utilising flyash.

Accordingly, there is provided a composition apparatus and methods for moulding an aggregate pellet that can be used in a light weight concrete. The composition comprises a mixture of flyash, sand, caustic soda diluted in water, and water.

### BRIEF DESCRIPTION OF THE DRAWING FIGURE

FIG. 1 is a schematic plan view of a flyash aggregate fabrication facility;

FIG. 2 is a schematic side view of the facility depicted in FIG. 1;

FIG. 3 is a side elevation view of the moulding apparatus and aggregate conveyor suggested by in FIG. 2;

FIG. 4 is a schematic side view of a pair of compression moulding cylinders in operation;

FIGS. 5(a), (b) and (c) are more detailed views of the moulding machine;

FIG. 6 is a schematic perspective view of a discharge conveyor and control room; and

FIG. 7 is a schematic perspective of the drying apparatus.

### BEST MODE AND OTHER EMBODIMENTS OF THE INVENTION

The successful utilisation flyash as a component of a commercially acceptable light weight aggregate was developed after considerable experimentation and testing over a five year period. A typical formula is shown below:

| | Weight in | Weight |
|---|---|---|
| Ingredient | Kilograms | in % |
| Flyash | 500 | 73 |
| Dune Sand | 55 | 8 |
| Binding Agent | 66 | 9.6 |
| Water | 64 | 9.3 |

The above weights have been varied by about 10% without apparent problems. Dune sand in the above table can be replaced by any other fine washed sand, as long as there are essentially no impurities in the fine washed sand. Preferably, the particle size of fine sands is similar to that of flyash. Flyash particles are rounded, whereas sand particles are not. Fine sand particles fit into the voids between flyash particles, and allow better compaction and bonding of the flyash particles. Course sand particles, which are larger than flyash particles, keep the flyash particles apart and do not allow optimum bonding and compaction. In the above formulation, the binding agent may be in the common commercially available liquid form with about 50% caustic soda and about 50% water. The binding agent may also be manufactured by mixing crystallized sodium hydroxide in 2˜10 weight percent (%) in 98˜90 weight percent (%) of water. Empirical tests have shown that a 6% crystallized sodium hydroxide concentration produces a good agent. The mixture of caustic soda and water is mixed well and allowed to cool before use. As will be explained, these materials are mixed and cast into the desired shapes (“pellets”) then transferred into a dryer which is heated at approximately 200° C. Pellets dry in the heater for a period of about 30 minutes or until dry. Note that the water content of the mixture before drying is approximately 18-20% in weight. The weight of a cubic meter of dried 13 mm aggregate made in accordance with the above formula is about 750 kilograms. The weight of the cubic meter of dried 15 mm aggregate is about 785 kilograms. Dryness of the pellets can be tested by measuring the weight of the pellets.

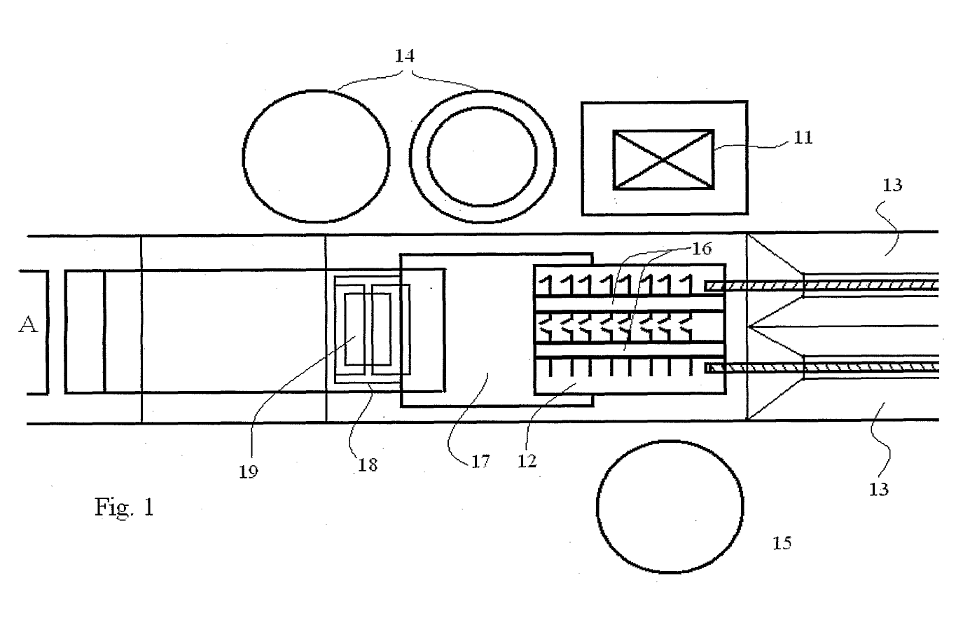

As shown in FIG. 1, a processing facility for fabricating pellets comprises a flyash holding silo 11 that receives flyash transferred from, for example, a powerhouse. Depending on the temperature of the flyash, the internal design of the silo 11 may need to differ from convention cement silos. The flyash holding silo 11 will be operated at negative pressure to allow filling to be carried out while discharging the silo into the mixing chamber 12. Ash that is fed from the silo 11 into the mixer 12 is measured, and the weight is recorded for process control and quality control purposes. The mixer 12 also receives the output of two 20 tonne in-line bins 13 that are used to discharge sand into the mixer 12. The mixer 12 also receives the output of two corrosion resistant liquid tanks 14 that use corrosion resistant pumps for discharging the binding agent. The discharge of this binding agent from the tanks 14 is also measured and recorded. A water tank 15 also discharges a monitored stream of “added” water into the mixer 12.

In preferred embodiments, the process is run as a continuous process and thus the mixer operates continuously. A mixer such as a pug mill with a capacity of 200-1000 tonnes per hour uses twin variable speed shafts 16 to deliver a continuous output of mixed ingredients onto a first conveyor 17. The mixer is computer controlled so that the rate of rotation of shafts 16 is variable and adaptable to a range or rotational speeds. The hydraulic driven shafts 16 move material forward and discharge the mixed material onto the conveyor 17 which moves the mixed material upward and forward into a bin 18 located above a moulding-machine 19.

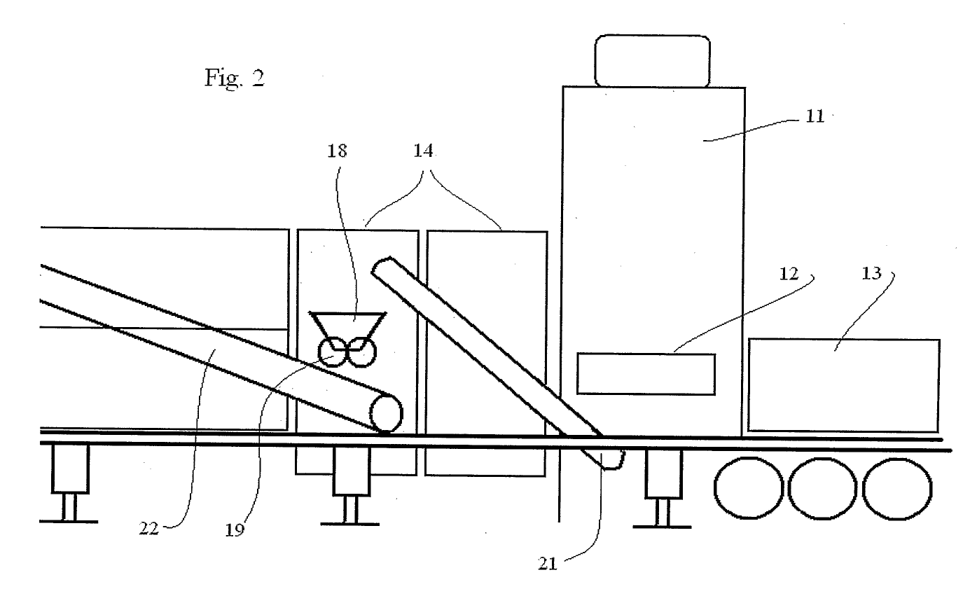

As suggested in FIGS. 2-6, the formulated mixture of flyash, sand, caustic soda and water is discharged from the mixer 12 onto an inclined mixed material conveyor 21. The conveyor deposits the mixture into a bin or hopper 18 that supplies a pair of counter rotating moulding cylinders 19. The operation of the moulding apparatus will be discussed below. The moist pelletised product of the moulding cylinders 19 is deposited onto the first conveyor 22 that supplies pellets to a pellet drying apparatus.

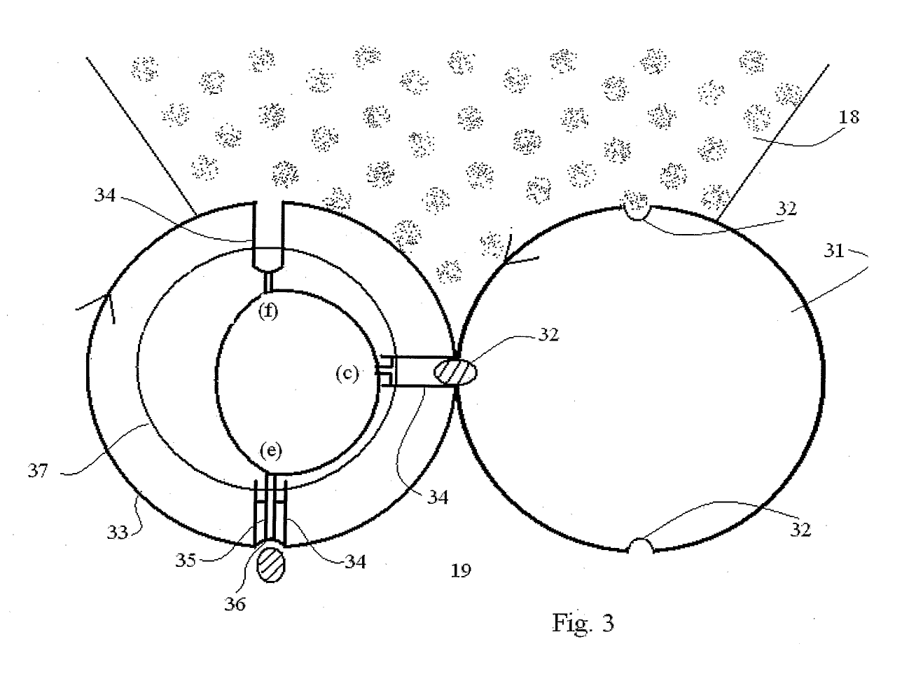

With reference to FIGS. 3-6, the primary components of the moulding apparatus comprise the hopper 18 and counter rotating moulding cylinders 19. As shown in FIG. 3, one of the moulding cylinders 31 has an outer surface in which are formed mould halves in the form of concavities 32. Each concavity 32 is preferably hemispherical, being approximately 9 mm deep and 18 mm in diameter. The other synchronised, rotating cylinder 33 comprises an array of cylindrical chambers 34, each associated with a reciprocating piston 35 whose operation is governed by a static cam 37 internal to the cylinder 33. As can be seen in FIG. 3, the rotation of the cylinder 33 around the cam 37 generates a working cycle that all of the cavities perform in the course of one rotation of the cylinder 33. Conceptually, each moulding chamber 34 has a fill phase (f) where the cylindrical chamber 34 fills with material contained in the hopper 18. The filled cylindrical chamber 34 travels toward a fully compressed orientation (c) where the cylindrical mould 34 comes into cooperating alignment with the corresponding concavity 32 and the piston 35 forces the mixture into its final generally spherical shape. Further rotation of the second forming cylinder 33 causes the cylindrical chamber 34 to become inverted whereupon the formed aggregate pellet may be discharged onto the formed aggregate conveyor 22.

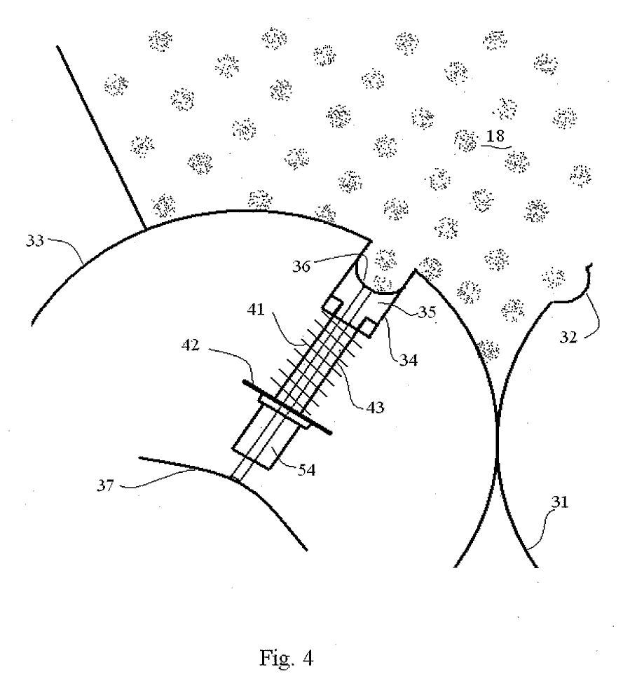

As shown in more detail in FIG. 4, the cylindrical cavity or piston guide 34 fills with the aggregate mixture in the hopper 18. Note that the piston 35 has a concave and generally hemispherical upper or mould surface 36. The piston 35 is urged into its retracted position by the compression spring 41. The location of the piston 35 within the cylindrical cavity 34 is determined by the location of a nut and washer arrangement 42 carried by the piston's threaded shaft 43. The threaded shaft 43 also carries a dome nut or other form of cam follower 54. Action on the cam follower 54 by the internal cam 37 causes the piston 35 to reciprocate within the guide or cavity 34. Note that the rotational speeds of the two cylinders 31, 33 are synchronised so that the piston 35 reaches its closest point with respect to a concavity 32 during the fully compressed orientation (c).

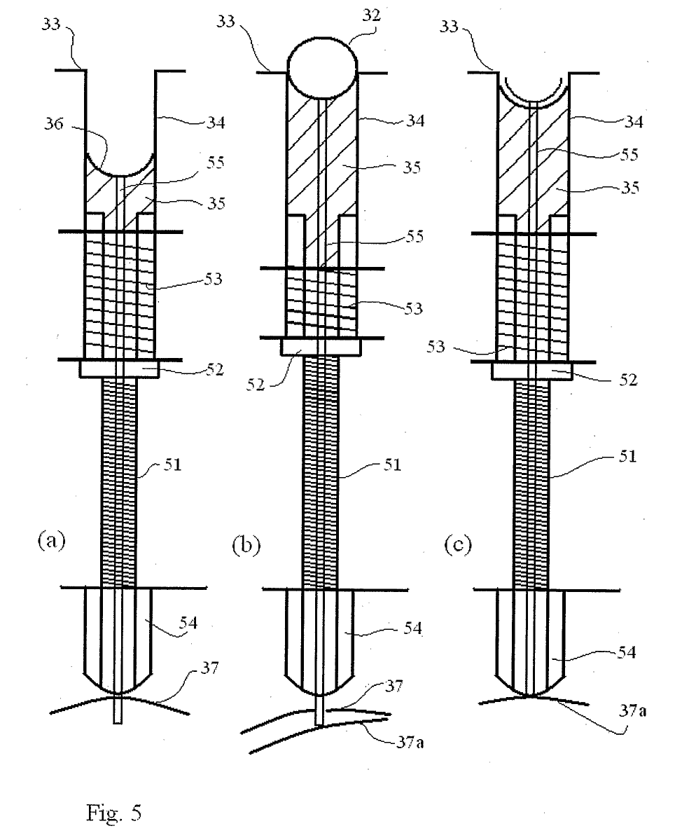

As suggested by FIG. 5(a)-(c) the cylindrical piston guide or chamber 34 supports its internal piston 35 during a reciprocating work cycle. One portion of the work cycle is described as the fill phase and is exemplified in FIG. 5(a). During this phase, the piston 35 with its hemispherical upper surface 36 is located at or near its lowest point in the cylindrical chamber 34. It is maintained in this position by the compression spring that biases the piston 35 into this lower position. At the lower end of the piston, a 10 mm threaded rod 51 protrudes below the cylindrical chamber 34 and a 50 mm long compression spring is fitted below the piston and above a flat washer and locknut 52. The spring 53 and locknut holds the piston down and into this charging position within the cylindrical guide at a predetermined depth to allow the required amount of loose material to enter the guide for a given pellet size. The inner end of the threaded rod 51 is threaded into or otherwise attached to a cam follower 54. Thus, the cam follower can be adjusted along the length of the threaded rod 51 to provide the required travel in the motion of the reciprocating piston 35.

The compressed orientation (seen as item (c) in FIG. 3) is shown in FIG. 5 (b). In this phase of operation, the concavity 32 and the piston guide 35 align as the piston 35 reaches the top of its travel with respect to the cam 37. It has been found that about 45 kg of pressure on the 18 mm diameter piston will create an optimised pellet.

As shown in FIG. 5 (c) if the pellet encounters difficulties in dropping out of the hemispherical mould formed by the upper surface 36 of the piston 35, an extractor or push rod 55 may be employed for the purpose of urging the pellet out of the mould and onto the conveyor 22. As shown in this example, the push rod 55 extends through a bore that passes through the entire length of the piston 35, threaded rod 51 and cam follower 54. In order to operate the extractor 55, a second static cam 37 (a) makes contact with the end of the extractor 55 during the inverted or ejection phase (item (e) in FIG. 3).

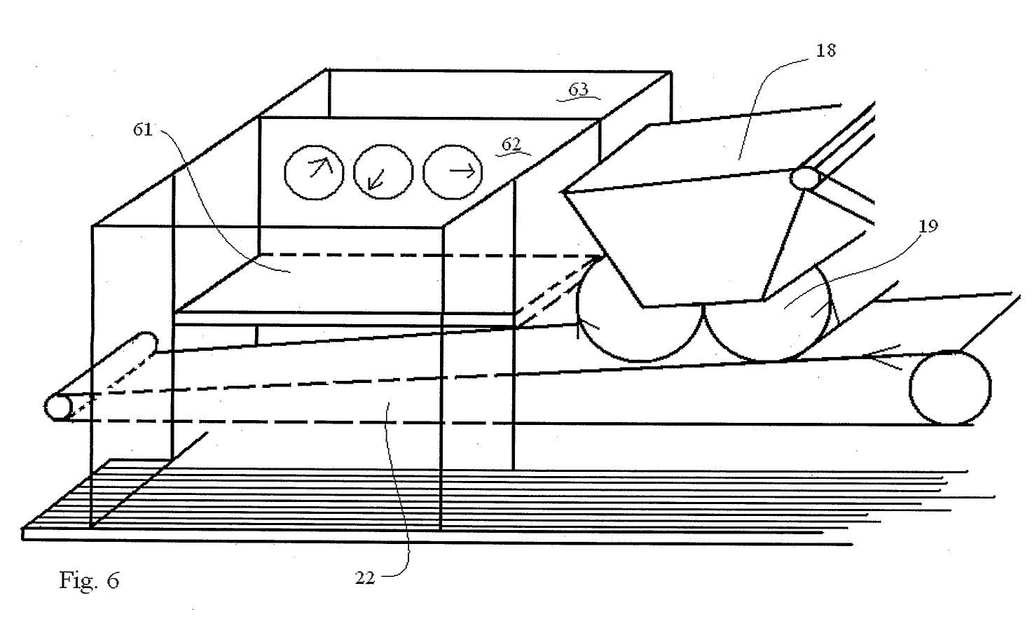

As shown in FIG. 6, the counter rotating moulding cylinders 19 deposit formed spherical pellets onto a discharge conveyor 22 that takes the moist but formed pellets to the drying apparatus. The conveyor belt 22 passes beneath a bench behind which is located a control panel 62. An operator's control room 63 is located behind the control panel 62. The control room contains process control equipment and is enclosed and suitably dustproof. The walls in the bench area and control room include glass inspection windows that allow the operator to view both the operation of the moulding cylinders 19 and the operation of the dryer as required. The conveyor 22 can pivot about the end closest to the rotating cylinders 19. This allows the conveyor to pivot under the bench 61 from a transport orientation to a second orientation where the end remote from the cylinders 19 can be lifted into a raised position to allow pellets to be fed into the top of the dryer.

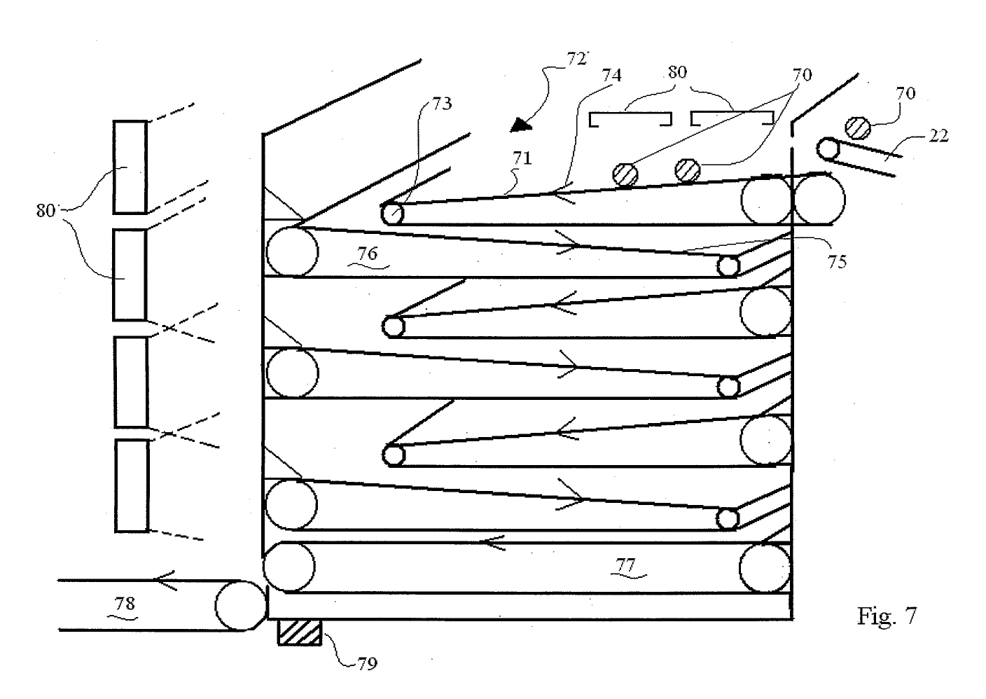

FIG. 7 illustrates an example of an array of wire weave conveyors contained within drying apparatus. Formed pellets 70 from the moulding apparatus 19 arrive on the upper surface 71 of the uppermost wire weave conveyor 72 from the formed aggregate conveyor 22. The moving wire weave surface of the upper conveyor 72 travels at a predetermined rate toward the smaller return spindle 73. Pellets 70 travelling in the direction of the arrow 74 on the upper surface of the uppermost conveyor will be discharged onto the upper surface 75 of the second conveyor 76. Similarly, the upper surface of the second conveyor 75 is formed from a wire weave material. In like fashion, the formed pellets are transported along the length of the second conveyor whereupon they are discharged consecutively onto the interdigitated third, forth, fifth, sixth and seventh conveyors. Note that each conveyor belt travels in an opposite direction than the ones that are adjacent to it. This creates a cascading motion of the pellets that allow the pellets to remain within the hot air dryer for as long as is required for the process parameters. Pellets are carried by the upper surface of the lowest conveyor 77 toward another conveyor 78 that deposits the dried aggregate pellets onto a stockpile. By weighing a measured sample of the pellets, it is possible to determine the weight of the pellets. Once the pellet weight is ascertained, the operator can speed up the conveyor belts if the pellet is light enough compared to the average dried aggregate weight, and slow down the conveyor belt if the pellet is still too heavy. The sampling and weighing may be done automatically by linking an internal conveyor belt speed control to a computer controlled conveyor belt weighting machine at the discharge point. A scavenger screw conveyor 79 may be utilised to gather accumulated waste from the drying area. A series of fans 80 supplies air or heated air into the internal cavity of the dryer.

By using interdigitating belts that travel in different directions, the pellets are turned or rotated as they are transferred from one belt to the next allowing the heated air to reach all parts of the pellet in order to achieve greater drying efficiency. The scavenger screw 79 can be fed by a chain and drawbar system that reciprocates along the floor of the drying so as to pick spillage and dust falling from the conveyors above. The scavenger screw 79 discharges outside of the dryer whereupon the waste can be collected, and recycled, for example, through the bins 13. In preferred embodiments, all of the conveyors are variable speed and hydraulically driven.

While the present invention has been disclosed with reference to particular details of construction, these should be understood as having been provided by way of example and not as limitations to the scope or spirit of the invention.

1-20. (canceled)

21. A formula for making aggregates for concrete, essentially comprising
flyash;
fine washed sand, wherein there are essentially no impurities in the fine washed sand;
binding agent; and
water.

22. The formula of claim 21, wherein,
the fine washed sand is dune sand.

23. The formula of claim 22, wherein,
the flyash is present in an amount of about 73 weight percent.

24. The formula of claim 23, wherein,
the fine washed sand is present in an amount of about 8 weight percent.

25. The formula of claim 24, wherein,
the binding agent is present in an amount of about 9.6 weight percent.

26. The formula of claim 25, wherein,
the binding agent is a solution of about 6 weight % crystallized sodium hydroxide in 94 weight % water.

27. The formula of claim 25, wherein,
the binding agent is a 50% caustic soda solution.

28. A method for producing aggregates for concrete, comprising the steps of:
mixing a set of aggregate ingredients into a mixture;
transferring the mixture to a moulding apparatus;
casting the mixture into pellets in the moulding apparatus;
transferring the pellets into a drying apparatus; and
drying the pellets.

29. The method of claim 28, wherein,
the set of ingredients essentially comprises about 73 weight percent flyash, about 8 weight percent dune sand, about 9.6 weight percent binding agent, and water, wherein the binding agent is a mixture of caustic soda and water.

30. The method of claim 28, wherein,
the moulding apparatus comprises two synchronized, counter rotating cylinders.

31. The method of claim 28, wherein,
the drying apparatus comprises a series of interdigitating conveyor belts.

32. The method of claims 28, wherein,
a computer controlled conveyor belt weighting machine weights the pellets at a discharge point of the drying apparatus, wherein a control of the machine is linked to an internal conveyor belt speed control.

33. A facility for producing aggregates for concrete, comprising:
a holding silo;
a mixing chamber, in which is located a mixer;
one or more liquid tanks in which one or more liquid pumps are used for discharging a binding agent mixture into the mixer;
an inclined mixed material conveyor that transfers an output from the mixer to a moulding apparatus in which the output is cast into pellets; and
a second conveyor that supplies the pellets to a drying apparatus.

34. The facility of claim 33, wherein,
the set of ingredients essentially comprises about 73 weight percent flyash, about 8 weight percent dune sand, about 9.6 weight percent binding agent, and water, wherein the binding agent is a mixture of caustic soda and water.

35. The facility of claim 33, wherein,
the moulding apparatus further comprises a first and a second counter-rotating and synchronized moulding cylinders.

36. The facility of claim 35, wherein,
the first moulding cylinder comprises an outer surface, in which are formed an array of concavities, the second moulding cylinder comprises an array of cylindrical chambers, wherein one concavity and one cylindrical chamber are in cooperating alignment in a fully compressed orientation.

37. The facility of claim 36, wherein,
each cylindrical chamber houses a reciprocating, spring loaded piston, the piston having a mould surface and being driven by a static cam in an interior of the second moulding cylinder.

38. The facility of claim 37, wherein,
the mould surface and the concavities are approximately hemispherical.

39. The facility of claim 37, wherein,
the mould surface is part of an extractor that extends through a bore in the piston and pushes the pellet out of the cylindrical chamber.

40. The facility of claim 33, wherein,
the drying apparatus comprises a series of fans and an array of conveyors, wherein adjacent conveyors travel in opposite directions.
